(19) United States
(12) Patent Application Publication
(10) Pub. No.: US 2013/0285478 A1
(43) Pub. Date: Oct. 31, 2013

(54) Safety Pin

(71) Applicants: Zhenhua Guo, Shenzhen (CN); Chunhao Wu, Shenzhen (CN); Kunhsien Lin, Shenzhen (CN); Yunshao Jiang, Shenzhen (CN); Yongqiang Wang, Shenzhen (CN); Xiande Li, Shenzhen (CN); Weibing Yang, Shenzhen City (CN); Minghu Qi, Shenzhen City (CN); Zenghong Chen, Shenzhen City (CN); Rui Lei, Shenzhen City (CN)

(72) Inventors: Zhenhua Guo, Shenzhen (CN); Chunhao Wu, Shenzhen (CN); Kunhsien Lin, Shenzhen (CN); Yunshao Jiang, Shenzhen (CN); Yongqiang Wang, Shenzhen (CN); Xiande Li, Shenzhen (CN); Weibing Yang, Shenzhen City (CN); Minghu Qi, Shenzhen City (CN); Zenghong Chen, Shenzhen City (CN); Rui Lei, Shenzhen City (CN)

(73) Assignee: SHENZHEN CHINA STAR OPTOELECTRONICS TECHNOLOGY CO. LTD., Guangdong (CN)

(21) Appl. No.: 13/510,956

(22) PCT Filed: May 4, 2012
(86) PCT No.: PCT/CN12/75095

§ 371 Date: May 21, 2012

(30) Foreign Application Priority Data
Apr. 27, 2012 (CN) 201210129110.9

(51) Int. Cl. F16P 3/20

(52) U.S. Cl. 307/328

(57) ABSTRACT

The present invention provides a safety pin which includes a cylinder having a first and second interfaces. A piston is moveably disposed within the cylinder to divide the cylinder into the first and second chambers. A safety pin is securely attached to the piston. A compressed air supplying device supplies the compressed air to the first and second chambers selectively. The safety made accordance with the present invention is securely attached to the piston which divides the cylinder into the first and second chambers. When the compressed air is injected into the first and second chambers selectively, the safety pin is extended or retracted so as to realize the lockup and unlock of the equipment eliminating human error resulted from negligence.

### FIELD OF THE INVENTION

The present invention to a safety pin, and more particularly, to a safety pin which can be manipulated automatically by means of a driving device.

### DESCRIPTION OF PRIOR ART

For those heavy equipments locked merely by a servo are really dangerous to those maintenance personnel if the equipments do not incorporated a deadbolt or safety pin in additional to the servo. There are plenty of moving parts within the heavy equipment, and during this revolving and transporting, it is mandatory to have a safety pin deadbolted to those moving or revolving parts so as to ensure a safety environment for the working personnel to perform the maintenance, repairs, and inspection. This is extremely important to the safety of those maintenance personnel so as to avoid any safety issues if those equipments are accidently triggered to operate or turned on with power.

However, any safety pin operated solely by human has a potential risk resulted from human negligence or risking personnel safety. For example, in some application, the safety pin is located at right under equipment which is hanging over the working position in which the safety pin is to set.

Accordingly, it is necessary to provide a safety pin so as to resolve the prior art issue.

### SUMMARY OF THE INVENTION

It is the objective of the present invention to provide a safety pin which can be operated automatically and remotely without risking personnel's safety.

In order to resolve the prior art problem, a safety pin is provided and it comprises a cylinder having a first interface and a second interface arranged in longitudinal ends. A piston is moveably disposed within the cylinder and dividing the cylinder into a first chamber in communication with the first interface and a second chamber in communication with the second interface. A dowel pin is securely attached to the piston. A compressed air supplying device is provided. And a solenoid has a third interface in communication with the first interface, and a fourth interface in communication with the second interface. The solenoid further includes an inlet interface interconnected to the compressed air supplying device and an exhaust interface. The solenoid selectively establishes an interconnection between the third interface and the inlet interface, and an interconnection between the fourth interface and the exhaust interface so as to push the piston and the dowel pin to move along a first direction so as to realize a lockup and unlock of equipment by means of the dowel pin.

Wherein the solenoid is switched to interconnect the third interface to the inlet interface, and the fourth interface to the exhaust interface in a first status, while the solenoid is switched to interconnect the third interface to the exhaust interface, and the fourth interface to the inlet interface in a second status.

Wherein the safety pin further includes a bracket to support the dowel pin, the safety pin projects out of the bracket under the first status so as to lockup the equipment.

Wherein the safety pin retracts into of the bracket under the second status so as to unlock the equipment.

Wherein the bracket is defined with through hole with the dowel pin moveably disposed within the thorough hole.

In order to resolve the prior art problem, a safety pin is provided and it comprises a cylinder having a first interface and a second interface. A piston is moveably disposed within the cylinder and divides the cylinder into a first chamber in communication with the first interface and a second chamber in communication with the second interface. A dowel pin is securely attached to the piston. And a compressed air supplying device supplies compressed air to the first chamber via the first interface, or alternatively supplying compressed air to the second chamber via the second interface so as to push the piston to move reciprocally along the first direction so as to realize a lockup and unlock of equipment by means of the dowel pin.

Wherein the safety pin further includes a solenoid having a third interface in communication with the first interface, and a fourth interface in communication with the second interface. The solenoid further includes an inlet interface interconnected to the compressed air supplying device and an exhaust interface. The solenoid selectively establishes an interconnection between the third interface and the inlet interface, and an interconnection between the fourth interface and the exhaust interface.

Wherein the solenoid is switched to interconnect the third interface to the inlet interface, and the fourth interface to the exhaust under the first status, and is switched to interconnect the third interface to the exhaust interface and the fourth interface to the inlet interface.

wherein the safety pin further includes a bracket to support the dowel pin, the safety pin projects out of the bracket under the first status so as to lockup the equipment.

Wherein the safety pin retracts into of the bracket under the second status so as to unlock the equipment.

Wherein the bracket is defined with through hole with the dowel pin moveably disposed within the thorough hole.

Wherein the first and second interfaces are located at longitudinal ends of the cylinder.

Wherein cylinder has a donut-shaped cross section.

The present invention can be concluded with the following advantages as compared to the prior art. The safety made accordance with the present invention is securely attached to the piston which divides the cylinder into the first and second chambers. When the compressed air is injected into the first and second chambers selectively, the safety pin is extended or retracted so as to realize the lockup and unlock of the equipment eliminating human error resulted from negligence.

### BRIEF DESCRIPTION OF DRAWINGS

FIG. 1 is an illustrational view of a first embodiment of a safety pin made in accordance with the present invention;

FIG. 2 is an illustrational view of the safety in FIG. 1 in which equipment is ready for lockup;

FIG. 3 is an illustrational view of the safety in FIG. 1 in which an equipment is ready for unlock;

FIG. 4 is an illustrational view of a second embodiment of a safety pin made in accordance with the present invention;

FIG. 5 is a diagram showing the working principle of the present invention;

FIG. 6 is an illustrational view of the safety in FIG. 4 in which equipment is ready for lockup;

FIG. 7 is an illustrational view of the safety in FIG. 4 in which an equipment is ready for unlock.

### DETAILED DESCRIPTION OF PREFERRED EMBODIMENT

A detailed description in view of accompanied drawings will be given herebelow.

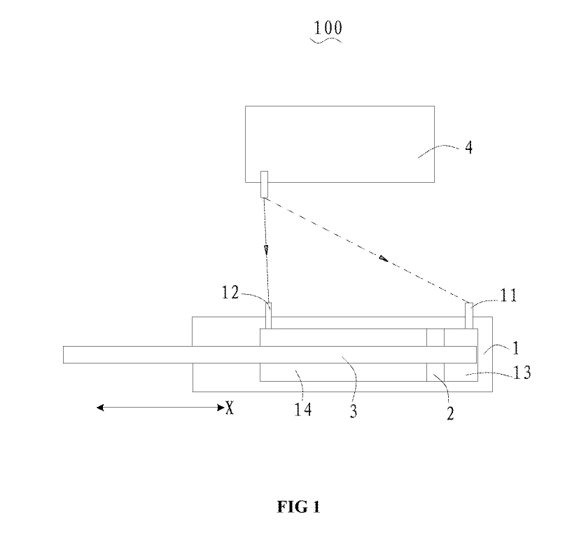

Referring to FIG. 1, the safety pin 100 made in accordance with the present invention includes a cylinder 1, a piston 2, a dowel pin 3, and a compressed air supplying device 4.

The cylinder 1 is incorporated with a first interface 11 and a second interface 12. The piston 2 is moveably disposed within the cylinder 1 such that the cylinder 1 is divided into a first chamber 13 and a second chamber 14. The first interface 11 is in communication with the first chamber 13, and the second interface 12 is in communication with the second chamber 14. The dowel pin 3 is securely attached to the cylinder 1.

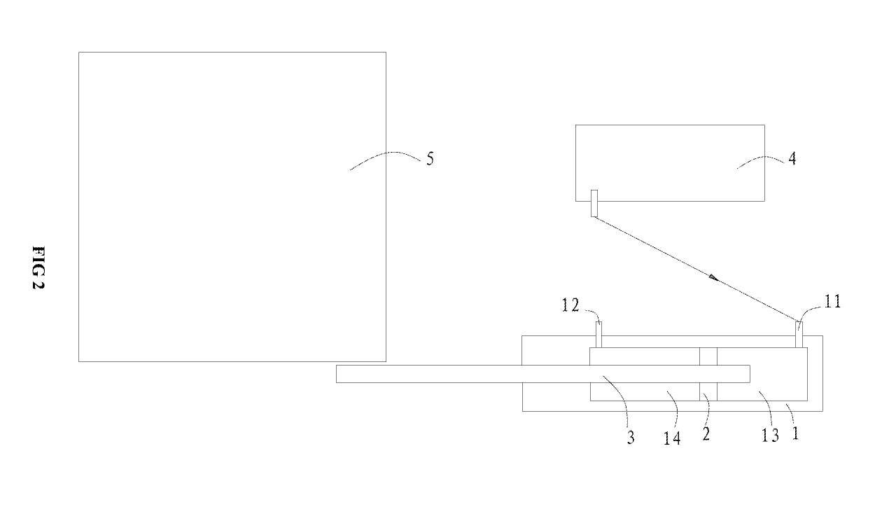

The compressed air supplying device 4 may supply the compressed air to the first chamber 13 through the first interface 11, or alternatively, supply the compressed air to the second chamber 14 via the second interface 12 such that the piston 2 and the dowel pin 3 attached thereto can move reciprocally along the first direction X. Referring in conjunction with FIG. 2, when the compressed air is supplied to the first interface 11 through the compressed air supplying device 4, the compressed air is further directed to the first chamber 13. With the increasingly built-up of the compressed air, the piston 2 along with the dowel pin 3 attached thereto starts to move along the first direction X so as to prepare the lockup of the equipment 5. As the piston 2 is moving toward the second chamber 14, the volume of the second chamber 14 shrinks as the air drains out from the second interface 12 while the volume of the first chamber 13 increases steadily. As a result, the dowel pin 3 extends gradually as the piston 2 moves toward the second chamber 14, and eventually, the equipment 5 is locked up.

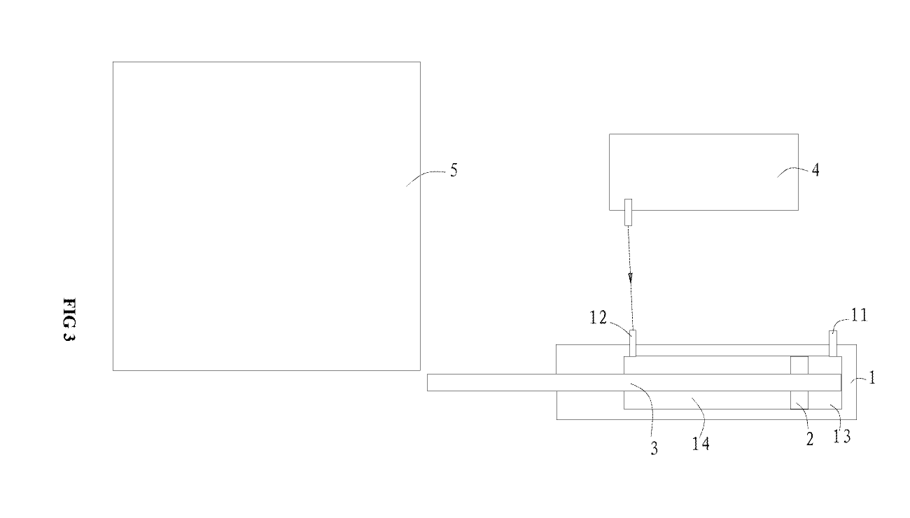

Referring to FIG. 3, once the equipment 5 is to be released, or unlocked, then the process is merely reversed. The compressed air is now supplied to the second chamber 12 from the compressed air supplying device 4. When the compressed air is built-up on the second chamber 12, the piston 2 starts to move from the second chamber 14 toward the first chamber 13 along the first direction X. Accordingly, the dowel pin 3 starts to retract from its locked up position as the second chamber 12 becomes increasingly enlarged with the built-up of the pressure, while the first chamber 11 starts to shrink as the air drained out. As a result, the dowel pin 3 retracts and eventually unlocks the equipment 5.

In order to enlarge the stroke of the dowel pin 3 along the first direction X, and increase the safety performance of the equipment 5 incorporated with the safety pin 100, the first and second interfaces 11 and 12 are located on longitudinal ends of the cylinder 1 along the first direction X.

In the preferred embodiment of the present invention, the cross sectional of the first and second chambers 13 and 15 is a circular, while the piston 2 is also circular. By this arrangement, a compact and airtight fit between the piston 2 and the first and second chambers 13 and 14 is ensured.

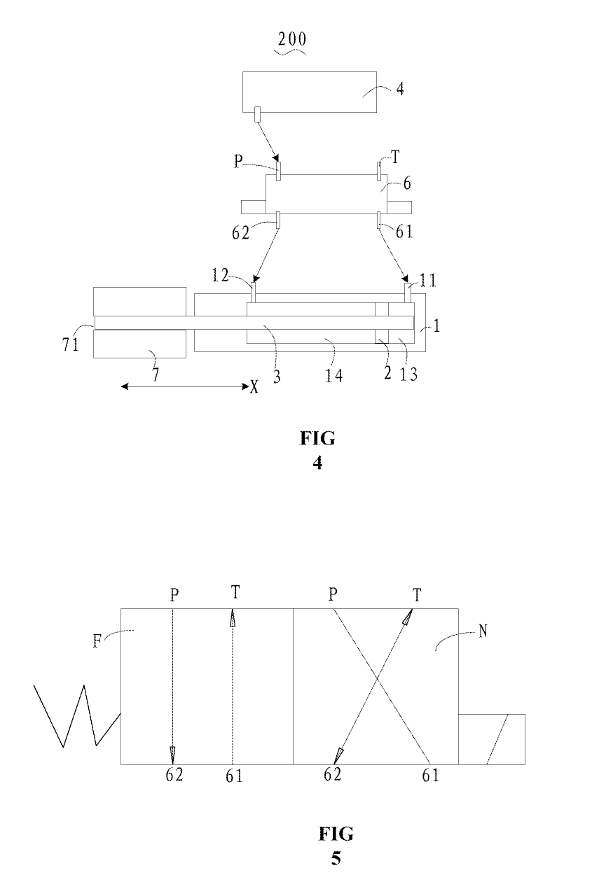

Referring to FIG. 4, a safety pin 200 is disclosed in accordance with a second embodiment of the present invention. As compared to the first embodiment, a solenoid 6 is provided between the compressed air supplying device 4 and the cylinder 1.

Substantially, the solenoid 6 in the present invention is a two-way-four-pass solenoid.

The solenoid 6 includes a third interface 61 in communication with the first interface 11, and a fourth interface 62 in communication with the second interface 12. The solenoid 6 further includes an inlet interface P and an exhaust interface T. The solenoid 6 selectively establishes interconnection between the third interface 61 and the inlet interface P, or the interconnection between the fourth interface 62 to the exhaust T.

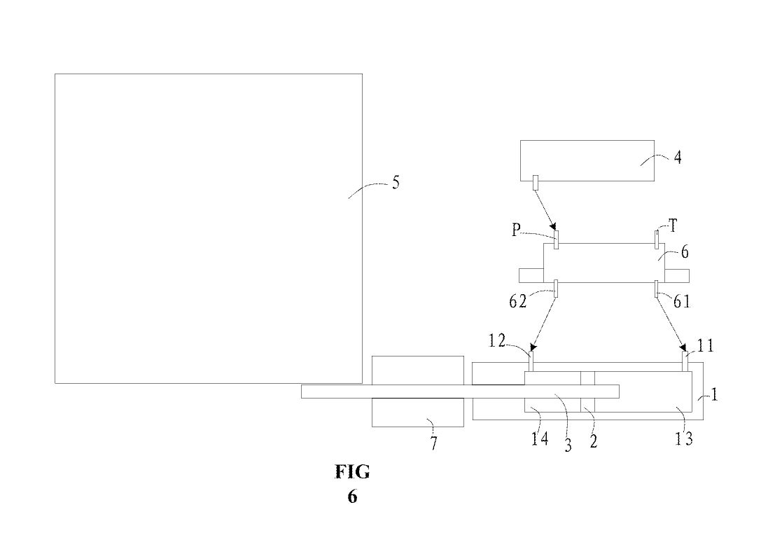

Referring to FIG. 5 as the working principle of the solenoid 6 is depicted. When the solenoid 6 is powered on, i.e. in N status, the third interface 61 is interconnected with the inlet interface P, and the fourth interface 62 is interconnected to the exhaust interface T. When the solenoid 6 is turned off, i.e. in the F status, the third interface 61 is interconnected to the exhaust interface T and the fourth interface 62 is interconnected to the inlet interface P.

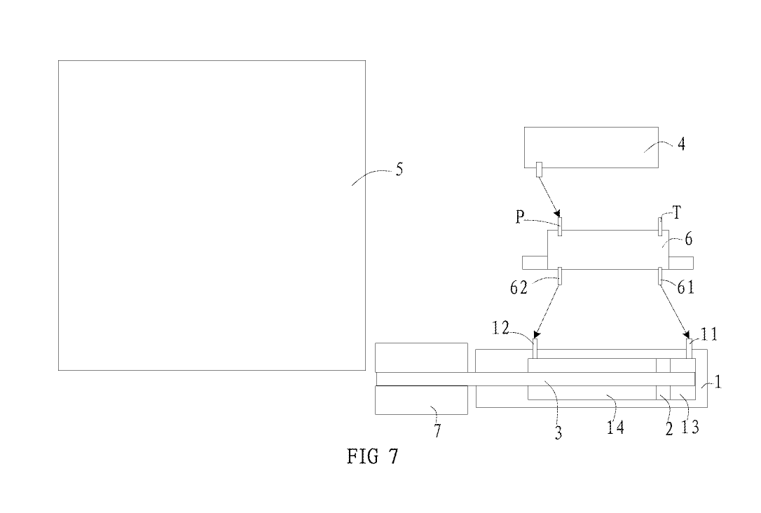

Referring to FIGS. 6 and 7, when using safety pin 200 incorporated with the solenoid 6 in controlling the lockup and unlock of the dowel pin 3 to the equipment 5, the details will be described herebelow. When the solenoid 6 is turned on, i.e. in N status, the dowel pin 3 is extended to lockup the equipment 5. When the solenoid 6 is turned off, i.e. in the F status, then dowel pin 3 retracts, and the equipment 5 is unlocked. It is very similar to the first embodiment, and no further description is given accordingly.

By providing with a solenoid 6 between the compressed air supplying device 4 and the cylinder 1, an operational process of switching between the first and second interfaces 11 and 12 in view of the compressed air supplying device 4 so as to control the displacement of the dowel pin 3 along the first direction X is omitted. By simply manipulating the solenoid 6, the lockup and unlock of the dowel pin 3 of the safety pin 200 with respect to the equipment 5 can be conveniently achieved.

Referring to FIGS. 4 to 7, according to the second embodiment of the safety pin 200 made in accordance to the present invention, a bracket 7 is incorporated. The bracket 7 includes a through hole 71, and the dowel pin 3 projected of the through hole 71 of the cylinder 1 is supported by the bracket 7. When the solenoid 6 is turned on and located at N status, the dowel pin 3 extends beyond the bracket 7 along the first direction X, and eventually lockup to the equipment 5. When the solenoid 6 is turned off, and located at the F status, the dowel pin 3 retrieves into the bracket 7, and therefore unlock the equipment 5.

By provision of the bracket 7, the safety pin 200 enhances its safety rating to the equipment 5. However, the above-described bracket 7 is merely a preferred embodiment, it should not impose any limitation thereto. For example, the bracket 7 may omit the through hole 71, and the exposed portion of the dowel pin 3 from the cylinder 1 can be located on the top of the bracket 7.

Similarly, when the solenoid 6 is turned off, i.e. located under F status, the dowel pin 3 will not extend beyond the bracket 7 along the first direction X. This should not be limited by the above description, as long as the dowel pin 3 can unlock the equipment 5 under the second status F.

The present invention can be concluded with the following advantages as compared to the prior art. The safety made accordance with the present invention is securely attached to the piston which divides the cylinder into the first and second chambers. When the compressed air is injected into the first and second chambers selectively, the safety pin is extended or retracted so as to realize the lockup and unlock of the equipment eliminating human error resulted from negligence.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A safety pin, comprising:
A cylinder having a first interface and a second interface arranged in longitudinal ends;
A piston moveably disposed within the cylinder and dividing the cylinder into a first chamber in communication with the first interface and a second chamber in communication with the second interface;
A dowel pin securely attached to the piston;
A compressed air supplying device; and
A solenoid having a third interface in communication with the first interface, and a fourth interface in communication with the second interface, the solenoid further including an inlet interface interconnected to the compressed air supplying device and an exhaust interface, the solenoid selectively establishing an interconnection between the third interface and the inlet interface, and an interconnection between the fourth interface and the exhaust interface so as to push the piston and the dowel pin to move along a first direction so as to realize a lockup and unlock of an equipment by means of the dowel pin.

2. The safety pin as recited in claim 1, wherein the solenoid is switched to interconnect the third interface to the inlet interface, and the fourth interface to the exhaust interface in a first status, while the solenoid is switched to interconnect the third interface to the exhaust interface, and the fourth interface to the inlet interface in a second status.

3. The safety pin as recited in claim 2, wherein the safety pin further includes a bracket to support the dowel pin, the safety pin projects out of the bracket under the first status so as to lockup the equipment.

4. The safety pin as recited in claim 3, wherein the safety pin retracts into of the bracket under the second status so as to unlock the equipment.

5. The safety pin as recited in claim 3, wherein the bracket is defined with through hole with the dowel pin moveably disposed within the thorough hole.

6. A safety pin, comprising:
A cylinder having a first interface and a second interface;
A piston moveably disposed within the cylinder and dividing the cylinder into a first chamber in communication with the first interface and a second chamber in communication with the second interface;
A dowel pin securely attached to the piston; and
A compressed air supplying device supplying compressed air to the first chamber via the first interface, or alternatively supplying compressed air to the second chamber via the second interface so as to push the piston to move reciprocally along the first direction so as to realize a lockup and unlock of an equipment by means of the dowel pin.

7. The safety pin as recited in claim 6, wherein the safety pin further includes a solenoid having a third interface in communication with the first interface, and a fourth interface in communication with the second interface, the solenoid further including an inlet interface interconnected to the compressed air supplying device and an exhaust interface, the solenoid selectively establishing an interconnection between the third interface and the inlet interface, and an interconnection between the fourth interface and the exhaust interface.

8. The safety pin as recited in claim 7, wherein the solenoid is switched to interconnect the third interface to the inlet interface, and the fourth interface to the exhaust under the first status, and is switched to interconnect the third interface to the exhaust interface and the fourth interface to the inlet interface.

9. The safety pin as recited in claim 8, wherein the safety pin further includes a bracket to support the dowel pin, the safety pin projects out of the bracket under the first status so as to lockup the equipment.

10. The safety pin as recited in claim 9, wherein the safety pin retracts into of the bracket under the second status so as to unlock the equipment.

11. The safety pin as recited in claim 9, wherein the bracket is defined with through hole with the dowel pin moveably disposed within the thorough hole.

12. The safety pin as recited in claim 6, wherein the first and second interfaces are located at longitudinal ends of the cylinder.

13. The safety pin as recited in claim 6, wherein cylinder has a donut-shaped cross section.
